(19) United States
(12) Patent Application Publication
(10) Pub. No.: US 2025/0033729 A1
(43) Pub. Date: Jan. 30, 2025

(54) Fuel Systems for Snowmobiles

(71) Applicant: Arctic Cat Inc., Thief River Falls, MN (US)

(72) Inventors: Guy L. Sibilleau, Roseau, MN (US); Kris Jorgenson, Thief River Falls, MN (US); Ralf Centmayer, Markdorf (DE); Nenad Malinovic, Emmingen-Liptingen (DE); Darin Jacobson, Newfolden, MN (US)

(73) Assignee: Arctic Cat Inc., Thief River Falls, MN (US)

(21) Appl. No.: 18/751,013

(22) Filed: Jun. 21, 2024

Related U.S. Application Data
(60) Provisional application No. 63/528,774, filed on Jul. 25, 2023.

(51) Int. Cl. B62J 35/00; B62J 37/00; B62M 27/02; F01N 13/10; F02M 35/16

(52) U.S. Cl. CPC B62J 35/00; B62J 37/00; B62M 27/02; F01N 13/10; F02M 35/162; B62M 2027/023; B62M 2027/028

(57) ABSTRACT

A fuel system for a snowmobile having a chassis defining an engine bay and an engine positioned within the engine bay. The fuel system includes a fuel tank that is coupled to the chassis and is positioned aft of the engine. The fuel tank has a forward face that includes a lower contour and an upper contour. A fuel rail is in fluid communication with the fuel tank and the engine. The fuel rail is positioned between the engine and the lower contour of the forward face of the fuel tank.

### CROSS-REFERENCE TO RELATED APPLICATIONS

The present application claims the benefit of U.S. Provisional Application No. 63/528,774, filed Jul. 25, 2023 the entire contents of which is incorporated by reference herein for all purposes.

### TECHNICAL FIELD OF THE DISCLOSURE

The present disclosure relates, in general, to fuel systems for use on land vehicles and, in particular, to fuel systems for use on snowmobiles that include a fuel tank having a contoured forward face that accommodates air intake components and fuel delivery components for compact positioned between an aftward side of the engine and the fuel tank.

### BACKGROUND

Snowmobiles are popular land vehicles used for transportation and recreation in cold and snowy conditions. Certain snowmobiles are designed for specific applications such as trail, utility, mountain, race and crossover, to name a few. Snowmobiles typically include a chassis that supports various components of the snowmobile such as a ground-engaging endless drive track disposed in a longitudinally extending tunnel. The drive track is powered by an engine that enables the drive track to provide ground propulsion for the snowmobile. One or more skis serve to facilitate steering as well as to provide flotation of the front of the snowmobile over the snow. A handlebar assembly is positioned forward of a seat and is operatively linked to the skis for controlling the snowmobile.

The exhaust system of a snowmobile directs high-temperature exhaust gases away from the engine and the rider of the snowmobile. The exhaust system typically includes an exhaust manifold, an exhaust duct and a muffler, each of which is prone to high operating temperatures as a result of the high-temperature exhaust gases flowing therethrough. For many snowmobiles, it is desirable to densely pack systems such as the air intake system, the engine, the exhaust system, the drivetrain and the fuel system to reduce the overall size and improve the aerodynamics and handling of the snowmobile. It has been found, however, that temperature-sensitive components near the exhaust system, such as the fuel system components, may be negatively impacted by close proximity to the hot temperatures of the exhaust system. Accordingly, a need has arisen for densely packing snowmobile systems while also spacing the temperature-sensitive components, such as the fuel system components, thermally distant from the exhaust system components.

### SUMMARY

In a first aspect, the present disclosure is directed to a fuel system for a snowmobile having a chassis defining an engine bay and an engine positioned within the engine bay. The fuel system includes a fuel tank that is coupled to the chassis and is positioned aft of the engine. The fuel tank has a forward face that includes a lower contour and an upper contour. A fuel rail is in fluid communication with the fuel tank and the engine. The fuel rail is positioned between the engine and the lower contour of the forward face of the fuel tank.

In certain embodiments, the fuel rail may extend laterally between the engine and the lower contour of the forward face of the fuel tank. In some embodiments, the fuel rail may be positioned below the upper contour of the forward face of the fuel tank. In certain embodiments, the fuel rail may be positioned aft of the engine. In some embodiments, the fuel rail may be positioned beneath at least a portion of the fuel tank and forward of at least a portion of the fuel tank. In certain embodiments, the snowmobile may include an air intake system that has a plurality of air outlets with the upper contour of the forward face of the fuel tank being configured to accommodate at least a portion of the air intake system between the engine and the fuel tank. In some embodiments, the fuel rail may extend laterally between a lower portion of the air intake system and the lower contour of the forward face of the fuel tank. In certain embodiments, the air intake system may include an air plenum that is positioned on top of the engine and air intake runners that are positioned at least partially between the engine and the upper contour of the forward face of the fuel tank with the fuel rail coupled to the air intake runners.

In a second aspect, the present disclosure is directed to a snowmobile that includes a chassis having a forward frame assembly that defines an engine bay and a tunnel that is coupled to the forward frame assembly. An engine is positioned within the engine bay and has a plurality of cylinders. An air intake system has at least one air inlet and a plurality of air outlets. Each of the air outlets is coupled to the engine and is configured to provide air to one of the cylinders. A fuel system includes a fuel tank that is coupled to the tunnel and is positioned aft of the engine and a fuel rail that is in fluid communication with the fuel tank and the engine. The fuel tank has a forward face that includes a lower contour and an upper contour. The fuel rail is positioned between the engine and the lower contour of the forward face of the fuel tank. At least a portion of the air intake system is positioned between the engine and the upper contour of the forward face of the fuel tank.

In some embodiments, the engine may be a four-stroke engine. In certain embodiments, the air intake system may include an airbox that includes the air inlet and air intake runners each including one of the air outlets. The air intake runners may be positioned at least partially between the engine and the upper contour of the forward face of the fuel tank. In some embodiments, the air intake runners may be positioned below at least a portion of the fuel tank. In certain embodiments, the air intake runners may be positioned at least partially beneath at least a portion of the fuel tank. In some embodiments, the air intake system may include an air plenum positioned on top of the engine with the air intake runners extending aftwardly and downwardly from the air plenum to the engine. In some embodiments, the fuel rail may be positioned below the upper contour of the forward face of the fuel tank. In certain embodiments, the fuel rail may be positioned beneath at least a portion of the fuel tank. In some embodiments, the fuel rail may extend laterally between the engine and the lower contour of the forward face of the fuel tank. In certain embodiments, the fuel rail may be positioned aft of the engine. In some embodiments, an exhaust system may include an exhaust manifold that is coupled to the engine and a muffler that is in fluid communication with the exhaust manifold. In certain embodiments, the exhaust manifold may be coupled to a forward side of the engine and the air outlets of the air intake system may be coupled to an aft side of the engine.

In a third aspect, the present disclosure is directed to a snowmobile having a chassis that includes a tunnel having an upper surface. An engine is coupled to the chassis. The engine includes one or more cylinders and a crankshaft having an axis of rotation. A fuel tank is positioned on the upper surface of the tunnel aft of the engine. The fuel tank has a forward face defining a first contour. A fuel rail is in fluid communication with the fuel tank and the engine. The fuel rail is received in the first contour between the fuel tank and the engine.

In certain embodiments, an air plenum may be positioned on top of the engine and a heat exchanger may be positioned at a forward end of the tunnel. In such embodiments, the crankshaft may be positioned a first distance from the heat exchanger and the air plenum may be positioned a second distance from the fuel tank with the first distance being greater than the second distance. In some embodiments, the heat exchanger may include a forward portion that defines a forward end of the tunnel. In such embodiments, a first plane may extend along the upper surface of the tunnel and a second plane may extends from the forward portion of the heat exchanger perpendicular to the first plane such that when the first plane is horizonal, the crankshaft is positioned below the first plane and forward of the second plane, and the fuel rail is positioned above the first plane and aftward of the second plane. Also, when the first plane is horizonal, at least a portion of the air plenum may be positioned aftward of the second plane. In certain embodiments, the engine may include one or more air intake inlets on an aftward side of the engine such that when the first plane is horizonal, the one or more air intake inlets are positioned aftward of the second plane. In addition, when the first plane is horizonal, the one or more engine air inlets may be positioned above the first plane. In some embodiments, the air plenum may include an air inlet such that when the first plane is horizonal, the air inlet of the air plenum may be positioned above the first plane and forward of the second plane. In certain embodiments, a throttle valve assembly may be in fluid communication with the air inlet of the air plenum such that when the first plane is horizonal, the throttle valve assembly is positioned above the first plane and forward of the second plane. In addition, the throttle valve assembly may be positioned outboard of a forward frame assembly of the chassis and/or may include a single throttle valve. In some embodiments, an air intake system may be in fluid communication with the throttle valve assembly with an air inlet positioned outboard of the forward frame assembly.

In certain embodiments, a third plane may extend through the axis of rotation of the crankshaft and the centerline of the one or more cylinders such that when the first plane is horizonal, the air inlet of the air intake system may be positioned above the first plane and forward of the second and the third planes and/or at least a portion of the throttle valve assembly and at least a portion of the air inlet of the air plenum may be positioned forward of the third plane. In some embodiments, when the first plane is horizonal, the throttle valve assembly may be positioned a first distance from the first plane and the air inlet of the air intake system may be positioned a second distance from the first plane that is greater than the first distance. In certain embodiments, the engine may include a water pump such that when the first plane is horizonal, the water pump may be positioned forward of the third plane and at least partially below the first plane. In some embodiments, when the first plane is horizonal, the second plane and the third plane may intersect at the air plenum. In certain embodiment, the engine may be a four-stroke, three cylinder engine.

In some embodiments, a first plane may extend along the upper surface of the tunnel and a second plane may extend from a forward portion of the fuel tank perpendicular to the first plane such that when the first plane is horizonal, the fuel rail may be positioned above the first plane and at least partially positioned aftward of the second plane. In certain embodiments, the fuel rail may be positioned entirely aftward of the second plane. In some embodiments, the fuel rail may include an inlet that is in fluid communication with the fuel tank such that when the first plane is horizonal, the fuel rail inlet may be positioned aftward of the second plane. In certain embodiments, an air plenum may be positioned on top of the engine with one or more air intake runners extending therefrom to one or more air intake inlets on an aftward side of the engine such that when the first plane is horizonal, at least a portion of the one or more air intake runners may be positioned aftward of the second plane. In such embodiments, when the first plane is horizonal, the one or more engine air inlets may be positioned above the first plane and forward of the second plane.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1E are schematic illustrations of a snowmobile having a fuel system in accordance with embodiments of the present disclosure;

FIG. 2 is an isometric view of an engine including an air intake system coupled to a forward frame assembly of a snowmobile in accordance with embodiments of the present disclosure;

FIGS. 3A-3E are various views of an engine including an air intake system and a fuel system for a snowmobile in accordance with embodiments of the present disclosure; and

FIGS. 4A-4B are front and side views of a fuel tank for use in a fuel system of a snowmobile in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

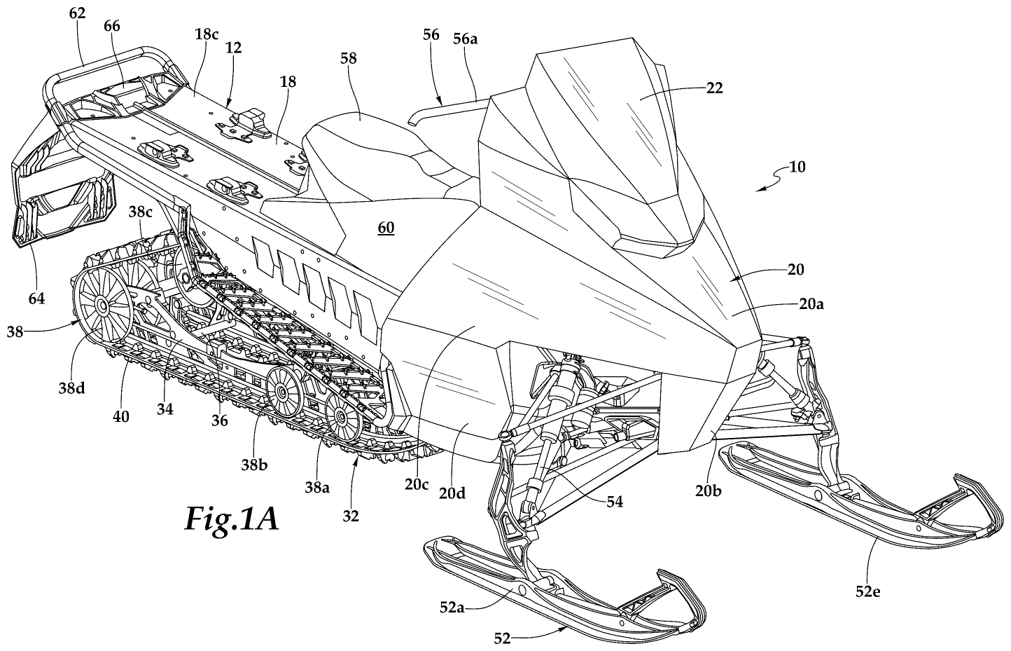

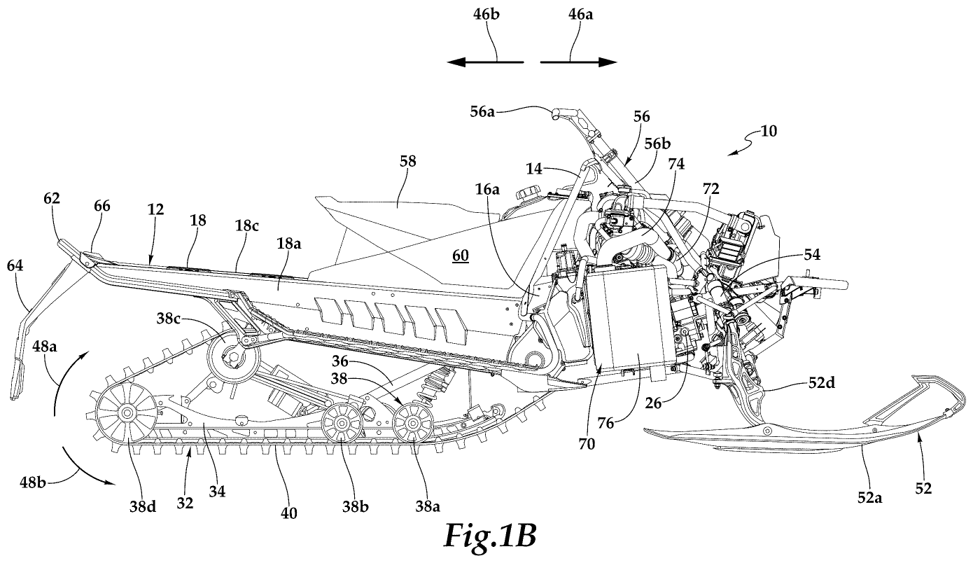

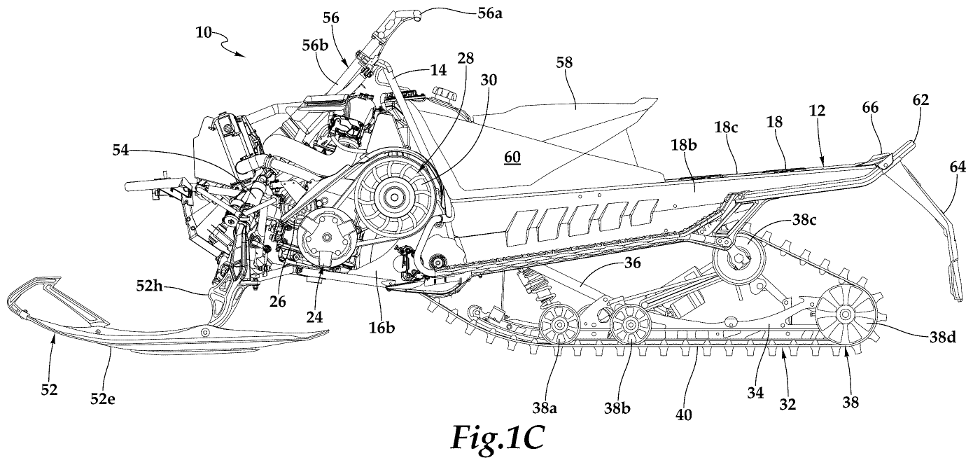

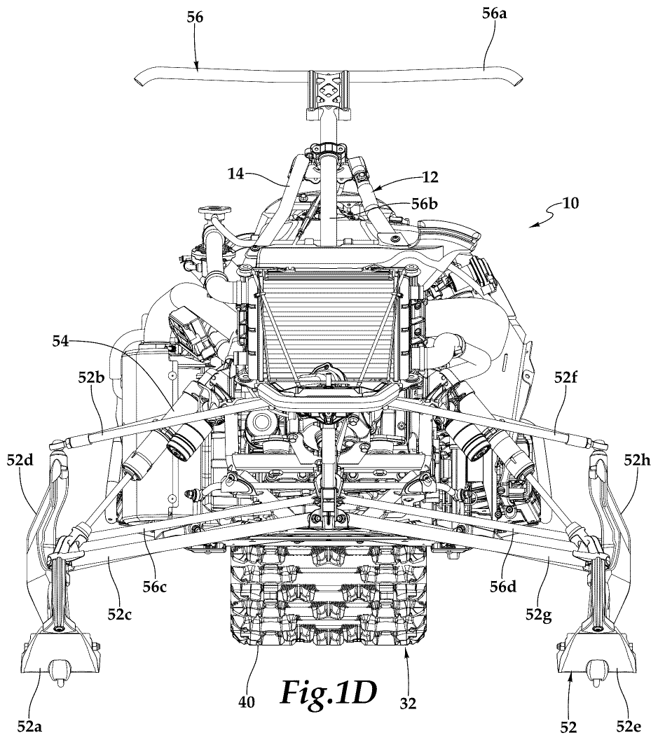

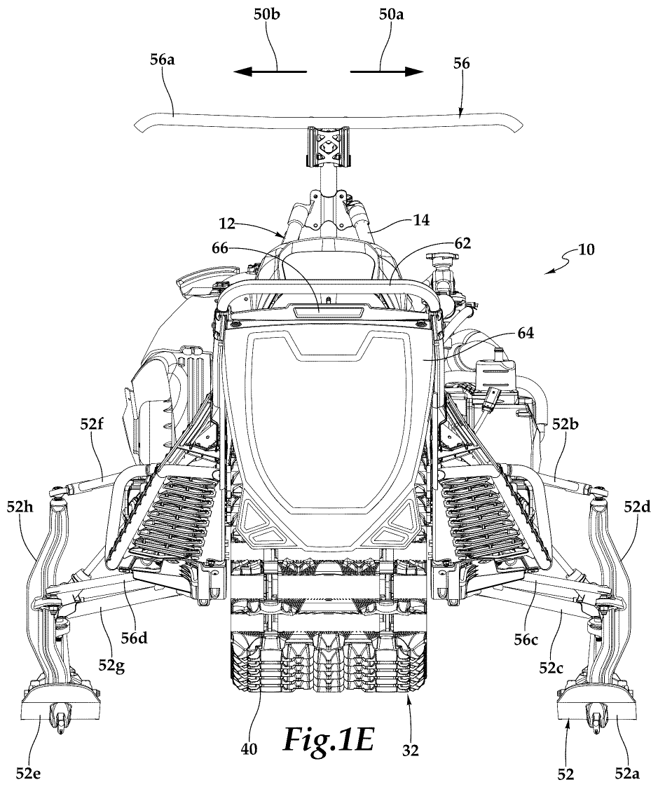

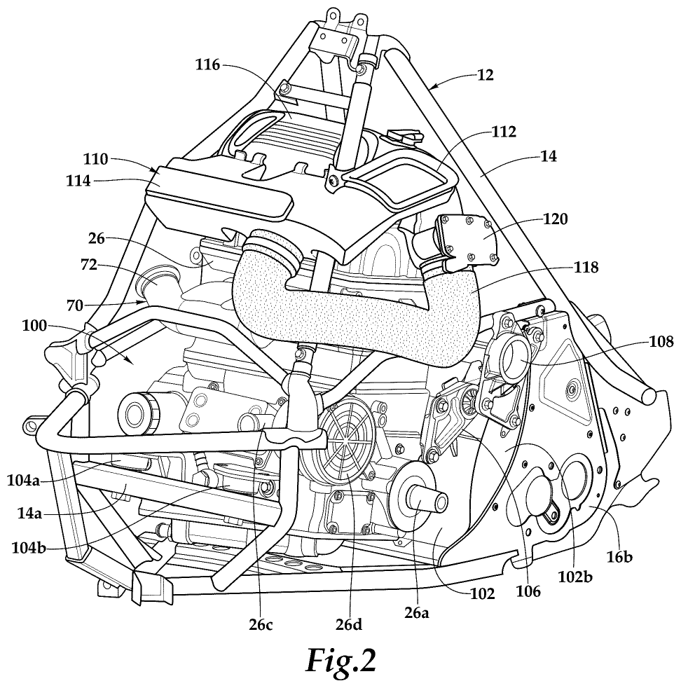

Referring to FIGS. 1A-1E in the drawings, a land vehicle depicted as a snowmobile is schematically illustrated and generally designated 10. Structural support for snowmobile 10 is provided by a chassis 12 that includes a forward frame assembly 14, a right side plate member 16a, a left side plate member 16b and a longitudinally extending tunnel 18. Forward frame assembly 14 (see also FIG. 2) is formed from interconnected tubular members such as round and hollow tubular members comprised of metal, metal alloy, polymeric materials, fiber reinforced polymer composites and/or combinations thereof that are coupled together by welds, bolts, pins or other suitable fastening means. Plate members 16a, 16b are coupled to and preferably welded to forward frame assembly 14 such that forward frame assembly 14 and plate members 16a, 16b form a welded frame assembly. Tunnel 18 is coupled to forward frame assembly 14 and/or plate members 16a, 16b with welds, bolts, rivets or other suitable means. In the illustrated embodiment, tunnel 18 includes a right sidewall 18a, a left sidewall 18b and a top panel 18c having a substantially planar upper surface. Tunnel 18 may be integrally formed or may consist of multiple members that are coupled together with welds, bolts, rivets or other suitable means. Plate members 16a, 16b and tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

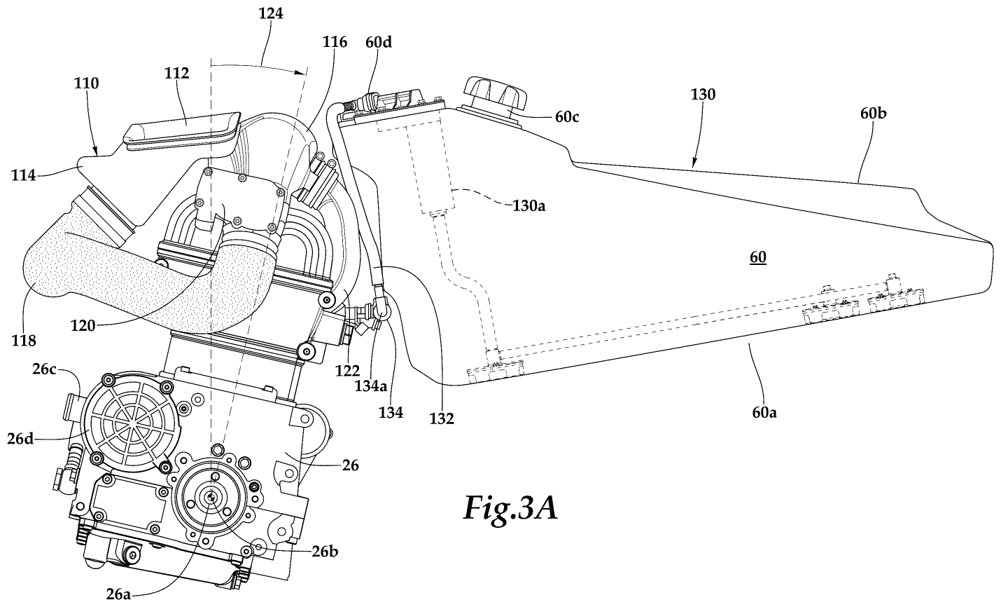

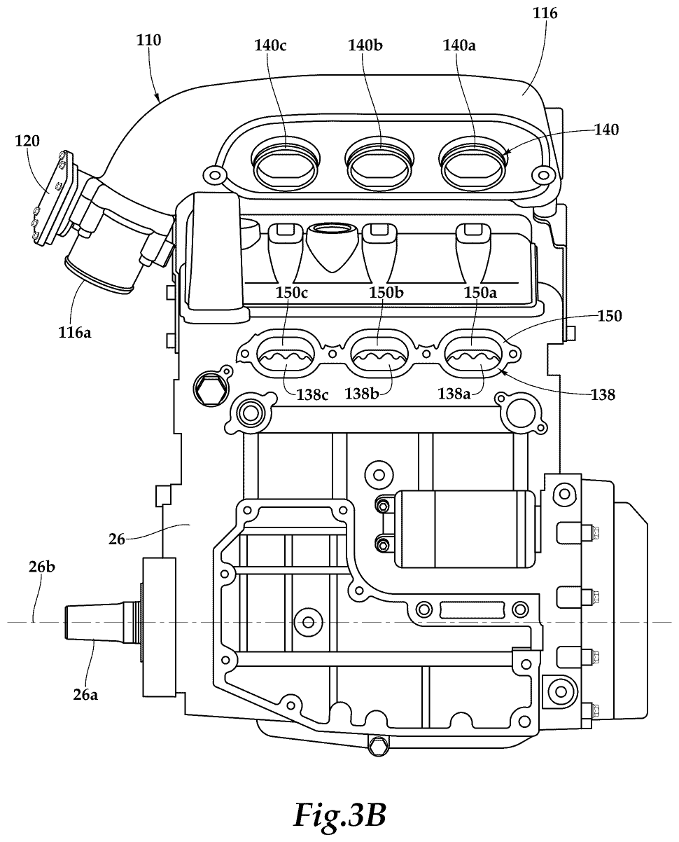

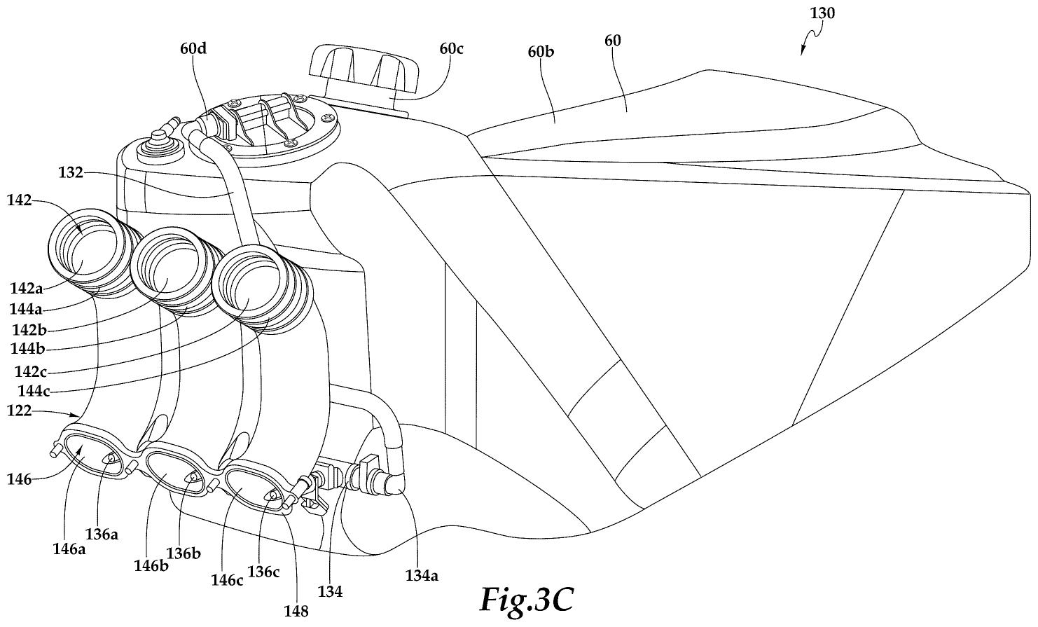

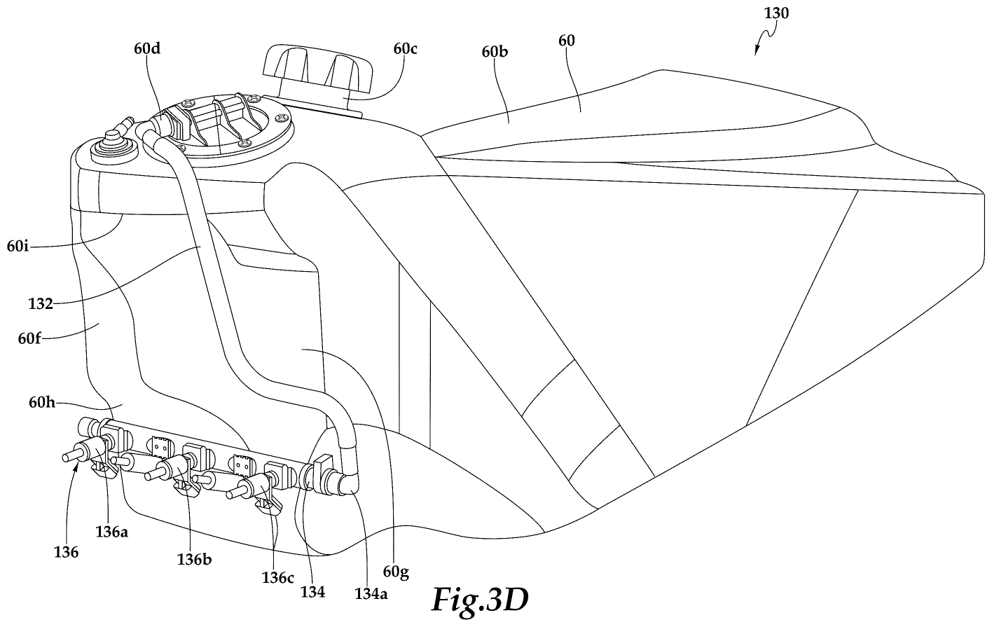

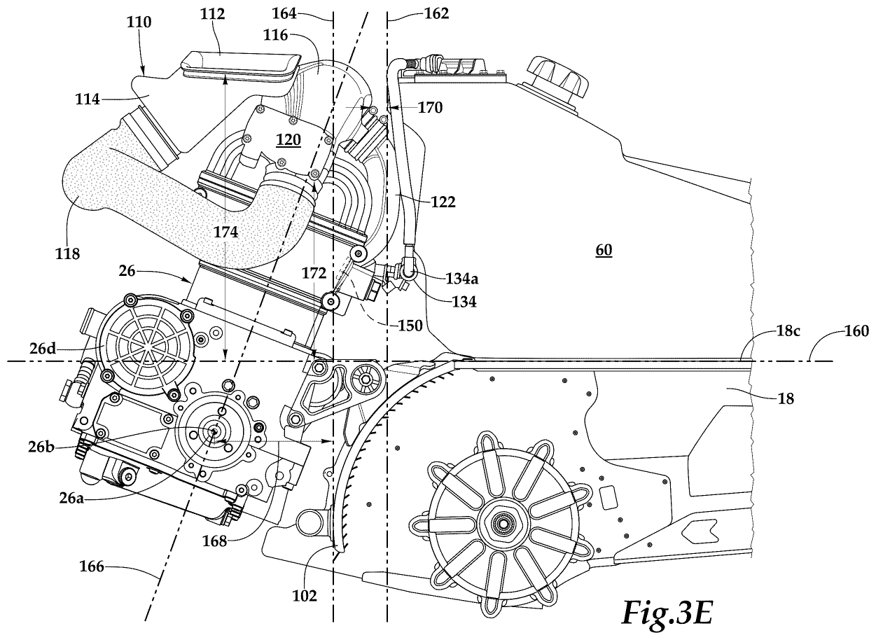

Body panels 20 have been removed from snowmobile 10 in FIGS. 1B-1E to reveal the underlying components of snowmobile 10. For example, snowmobile 10 has a powertrain 24 that includes an engine 26 and a drivetrain 28 both of which are coupled to forward frame assembly 14. Engine 26 resides in an engine bay formed within forward frame assembly 14. In the illustrated embodiment, engine 26 is a four-stroke, three cylinder engine that is aftwardly tilted and has air intake inlets on the aftward side of engine 26 and exhaust outlets on the forward side of engine 26. In other embodiments, an engine of the present disclosure may be a two-stroke engine, an electric motor, a hybrid engine or other prime mover. In addition, an engine of the present disclosure may have more than or less than three cylinders, may be vertically mounted or mounted with a forward tilt and/or may have air intake inlets or exhaust outlets in other locations. In the illustrated embodiment, engine 26 is an internal combustion engine such as a naturally aspirated internal combustion engine, a supercharged internal combustion engine or a turbo charged internal combustion engine. Engine 26 may be an interchangeable engine of the type disclosed in commonly owned U.S. patent application Ser. No. 18/649,993, filed Apr. 29, 2024, the entire contents of which are incorporated by reference herein for all purposes. Engine 26 includes a crankshaft 26a that has an axis of rotation 26b (see also FIGS. 2, 3B). Crankshaft 26a is coupled to drivetrain 28 and specifically to a transmission 30 of drivetrain 28 such as a continuously variable transmission, an electrically variable transmission or other suitable transmission type for varying the ratio of the engine output speed to the drive track input speed. Engine 26 includes a fluid inlet port 26c on the forward side of engine 26. Fluid inlet port 26c is in fluid communication with a water pump 26d that circulates a fluid through engine 26 and a cooling circuit including, for example, a radiator and one or more heat exchangers, such that heat extracted from the engine by the fluid is removed from the fluid in the cooling circuit as the fluid circulates therethrough.

A drive track system 32 is at least partially disposed within and/or below tunnel 18 and is in contact with the ground to provide ground propulsion for snowmobile 10. Torque and rotational energy are provided to drive track system 32 from engine 26 via drivetrain 28. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket via a track driveshaft (not visible) that is rotated responsive to torque provided from powertrain 24. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1E. The backward direction may also be referred to herein as the aftward direction.

Snowmobile 10 has a ski system 52 and a front suspension assembly 54 that provide front end support for snowmobile 10. Ski system 52 includes a right ski 52a that is coupled to forward frame assembly 14 by upper and lower A-arms 52b, 52c and right spindle 52d. Ski system 52 also includes a left ski 52e that is coupled to forward frame assembly 14 by upper and lower A-arms 52f, 52g and left spindle 52h. Skis 52a, 52e are interconnected to a steering system 56 including a handlebar assembly 56a, a steering column 56b, a right tie rod 56c and a left tie rod 56d that enable the rider to steer snowmobile 10. For example, when handlebar assembly 56a is rotated, skis 52a, 52e responsively pivot to turn snowmobile 10. The rider controls snowmobile 10 from a seat 58 that is position atop a fuel tank 60, above tunnel 18, aft of handlebar assembly 56a and aft of forward frame assembly 14. Snowmobile 10 has a lift bumper 62 that is coupled to an aft end of tunnel 18 that enables a person to lift the rear end of snowmobile 10 in the event snowmobile 10 becomes stuck or needs to be repositioned when it is not moving. Snowmobile 10 has a snow flap 64 that deflects snow emitted by endless track 40. In the illustrated embodiment, snow flap 64 is coupled to lift bumper 62. In other embodiments, a snow flap may be coupled directly to tunnel 18. A taillight housing 66 is also coupled to lift bumper 62 and houses a taillight of snowmobile 10. Snowmobile 10 has an exhaust system 70 that includes an exhaust manifold 72 that is coupled to engine 26, an exhaust duct 74 and a muffler 76. Exhaust system 70 is configured to direct high-temperature exhaust gases away from engine 26 and the rider of snowmobile 10.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

Referring additionally to FIG. 2 of the drawings, details relating to engine 26 of snowmobile 10 will now be discussed. Engine 26 is positioned within an engine bay 100 defined by forward frame assembly 14 and arcuate heat exchanger 102 that is positioned at the forward end of tunnel 18 such that the forward portion of arcuate heat exchanger 102 may be considered as the forward end of tunnel 18. Arcuate heat exchanger 102 is coupled to forward frame assembly 14, plate members 16a, 16b and/or tunnel 18. Arcuate heat exchanger 102 is positioned aft of a lower portion of engine 26 and below fuel tank 60. In the illustrated embodiment, engine 26 is resiliently secured within engine bay 100 by a pair of forward engine mounts 104a, 104b that are coupled to a cross member 14a of forward frame assembly 14 and a pair of rear engine mounts, only left-rear engine mount 106 being visible, that are coupled to a forward face of arcuate heat exchanger 102. Left-rear engine mount 106 is also coupled to a driven shaft bearing hub 108 that is coupled to forward frame assembly 14, plate member 16b and an end cap 102b of arcuate heat exchanger 102. Engine 26 has an air intake system 110 that receives air from the atmosphere and distributes the air to each of the cylinders of engine 26. More specifically, air intake system 110 includes an air inlet 112 that is positioned outboard of forward frame assembly 14 that feeds air into an airbox 114 that is positioned generally forward and generally above engine 26. Air from airbox 114 is routed to an air intake manifold via an air duct 118. The air intake manifold includes an air plenum 116 that is positioned on top of engine 26 and has an air inlet 116a (see also FIG. 3B) that is positioned outboard of forward frame assembly 14. The volume of air delivered to air plenum 116 from airbox 114 is controlled via a throttle valve assembly 120 that is positioned outboard of forward frame assembly 14 and has, for example, a single throttle valve disposed therein. The air intake manifold also includes air intake runners 122. Air plenum 116 is configured to damp the air flow prior to distribution of the air to the cylinders of engine 26 via air intake runners 122 (see also FIG. 3A). Engine 26 has exhaust system 70 (see also FIG. 1B) that includes exhaust manifold 72 that is coupled to the forward side of engine 26, which is also considered to be the hot side of engine 26 due to the hot temperatures associated with engine exhaust. The aft side of engine 26 is concomitantly considered the cool side of engine 26 as hot exhaust system components are located opposite and/or remote therefrom.

Referring additionally to FIGS. 3A-3E of the drawings, addition details relating to the positioning of engine 26 and fuel tank 60 of snowmobile 10 will now be discussed. Engine 26 is aftwardly tilted relative to vertical as indicated by arrow 124. In the illustrated embodiment, engine 26 is aftwardly tilted between five degrees and twenty degrees from vertical such as about ten degrees from vertical. It should be understood by those having ordinary skill in the art that engine 26 could have other aftwardly tilted angles both less than five degrees or greater than twenty degrees from vertical. Snowmobile 10 has a fuel system 130 that is positioned aft of engine 26 and more particularly, fuel system 130 is compactly positioned aft of engine 26. Fuel system 130 includes fuel tank 60 that is positioned on tunnel 18 (see also FIG. 1C). Fuel tank 60 has a lower surface 60a that is supported by the upper surface of top panel 18c of tunnel 18. Fuel tank 60 also has an upper surface 60b that receives seat 58 on an aft portion thereof and has a fill port 60c and a discharge port 60d at a forward portion thereof. In the illustrated embodiment, discharge port 60d forms the uppermost part of fuel tank 60 with each of fill port 60c and discharge port 60d positioned above engine 26. Fuel system 130 includes a fuel pump 130a that is positioned within fuel tank 60. Fuel system 130 also includes a fuel conduit 132 that fluidically couples fuel tank 60 with an inlet 134a of a fuel rail 134. Fuel pump 130a provides high pressure fuel to fuel rail 134 via fuel conduit 132. Fuel system 130 includes a multi-point fuel injector system 136 that is coupled to fuel rail 134 and is configured to inject fuel into the cylinders 138 of engine 26. In the illustrated embodiment, fuel injector system 136 include a right fuel injector 136a, a center fuel injector 136b and a left fuel injector 136c wherein, right fuel injector 136a injects fuel into right cylinder 138a of engine 26, center fuel injector 136b injects fuel into center cylinder 138b of engine 26 and left fuel injector 136c injects fuel into left cylinder 138c of engine 26. As such, each of the fuel injectors 136a, 136b, 136c injects fuel into a respective one of the three cylinders 138a, 138b, 138c of engine 26.

Referring specifically to FIGS. 3B-3C, air plenum 116 is positioned on top of engine 26 and includes a plurality of air discharge ports 140; namely, right air discharge port 140a, center air discharge port 140b and left air discharge port 140c. Air intake runners 122 include a plurality of air inlet ports 142; namely, right air inlet port 142a, center air inlet port 142b and left air inlet port 142c. Right air discharge port 140a is in fluid communication with right air inlet port 142a via a right coupling 144a. Center air discharge port 140b is in fluid communication with center air inlet port 142b via a center coupling 144b. Left air discharge port 140c is in fluid communication with left air inlet port 142b via a left coupling 144c. Air intake runners 122 also include a plurality of air outlet ports 146; namely, right air outlet port 146a, center air outlet port 146b and left air outlet port 146c. Air outlet ports 146 serve as the air outlets for air intake system 110. Air intake runners 122 include a flange 148 that mates to an aft side of engine 26 at air intake inlets 150, such that air intake runners 122 may be coupled to engine 26 using bolts or other suitable fasteners. In this position, right air outlet port 146a is aligned to provide air to right cylinder 138a through right air intake inlet 150a, center air outlet port 146b is aligned to provide air to center cylinder 138b through center air intake inlet 150b and left air outlet port 146c is aligned to provide air to left cylinder 138c through left air intake inlet 150c. In addition, right fuel injector 136a is coupled to air intake runners 122 proximate right air outlet port 146a, center fuel injector 136b is coupled to air intake runners 122 proximate center air outlet port 146b and left fuel injector 136c is coupled to air intake runners 122 proximate left air outlet port 146c. In this configuration, right fuel injector 136a is aligned to inject fuel into right cylinder 138a, center fuel injector 136b is aligned to inject fuel into center cylinder 138b and left fuel injector 136c is aligned to inject fuel into left cylinder 138c.

Referring specifically to FIG. 3E of the drawings, engine 26 and fuel tank 60 are shown in their installed positions relative to tunnel 18. In the illustrated orientation, the top surface of top panel 18c of tunnel 18 defines a tunnel plane 160 that is depicted as a horizontal plane. It is to be understood by those having ordinary skill in the art that a snowmobile of the present disclosure can be positioned in a variety of orientations. For example, in FIGS. 1B-1E, snowmobile 10 is depicted as having skis 52a, 52e and track drive 40 on a horizonal surface such that a tunnel plane would have an angle relative to a horizontal place such as an angle between five degrees and ten degrees or an angle of about eight degrees. In FIG. 3E, however, the orientation of tunnel plane 160 has been set to the horizontal to establish a convenient reference frame. In addition to tunnel plane 160, FIG. 3E illustrates a fuel tank plane 162 that is depicted as a vertical plane that touches the forwardmost point of fuel tank 60 and is perpendicular to tunnel plane 160, an arcuate heat exchanger plane 164 that is depicted as a vertical plane that touches the forwardmost point of arcuate heat exchanger 102, is perpendicular to tunnel plane 160 and is forward of arcuate heat exchanger plane 164, and a crankshaft plane 166 that is depicted as a tilted plane that passes through axis of rotation 26b of crankshaft 26a and the centerline of the cylinders 138 of engine 26.

Relationships between various snowmobile components and the identified planes will now be disclosed. Crankshaft 26a is positioned a first distance 168 from heat exchanger 102, as represented by arcuate heat exchanger plane 164, and air plenum 116 is positioned a second distance 170 from fuel tank 60, a represented by fuel tank plane 162, with the first distance 168 being greater than the second distance 170. Crankshaft 26a is positioned below tunnel plane 160 and forward of arcuate heat exchanger plane 164. Fuel rail 134 is positioned above tunnel plane 160 and aftward of arcuate heat exchanger plane 164. At least a portion of air plenum 116 is positioned aftward of arcuate heat exchanger plane 164. Air intake inlets 150 are positioned aftward of arcuate heat exchanger plane 164 and above tunnel plane 160. Air inlet 116a (see also FIG. 3B) of air plenum 116 is positioned above tunnel plane 160 and forward of arcuate heat exchanger plane 164. Likewise, throttle valve assembly 120 is positioned above tunnel plane 160 and forward of arcuate heat exchanger plane 164.

Air inlet 112 of air intake system 110 is positioned above tunnel plane 160 and forward of arcuate heat exchanger plane 164. At least a portion of throttle valve assembly 120 and at least a portion of air inlet 116a of air plenum 116 is positioned forward of crankshaft plane 166. Throttle valve assembly 120 is positioned a first distance 172 from tunnel plane 160 and air inlet 112 of air intake system 110 is positioned a second distance 174 from tunnel plane 160 that is greater than first distance 172. Water pump 26d is positioned forward of crankshaft plane 166 and at least partially below tunnel plane 160. Arcuate heat exchanger plane 164 and crankshaft plane 166 intersect at air plenum 116. Fuel rail 134 is positioned above tunnel plane 160 and at least partially positioned aftward of fuel tank plane 162. In the illustrated embodiment, fuel rail 134 is positioned entirely aftward of fuel tank plane 162. Fuel rail inlet 134a is positioned aftward of fuel tank plane 162. At least a portion of air intake runners 122 is positioned aftward of fuel tank plane 162. Air intake inlets 150 are positioned above tunnel plane 160 and forward of fuel tank plane 162.

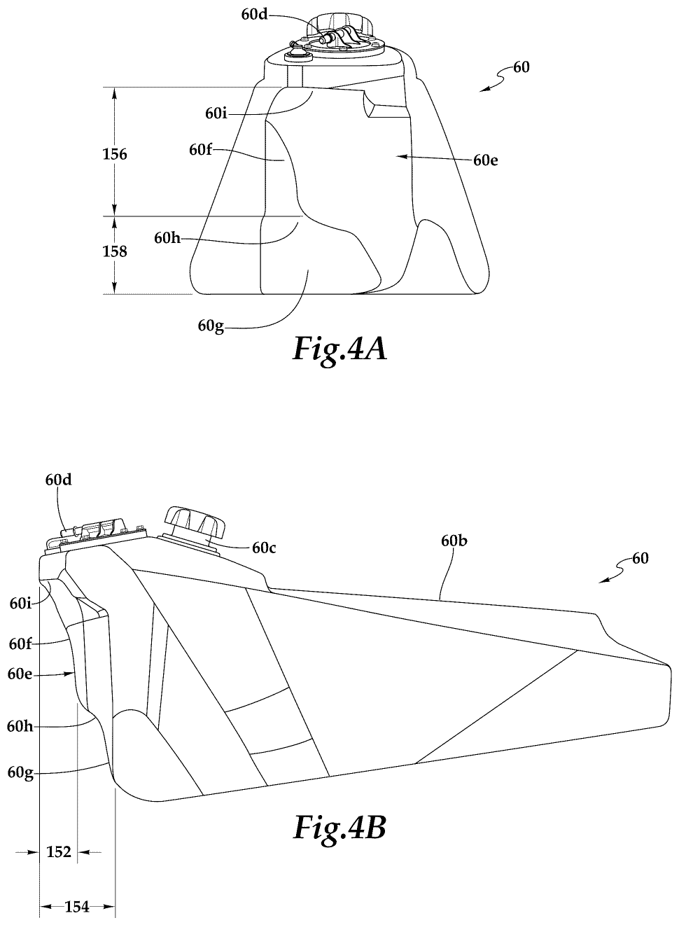

Referring additionally to FIGS. 4A-4B, addition features of fuel tank 60 will now be discussed. Fuel tank 60 is uniquely shaped to allow for compact positioning of fuel tank 60 relative to engine 26 and, in particular, relative to the cool side of engine 26 when engine 26 is oriented with an aftward tilt. For example, fuel tank 60 has a forward face 60e with a plurality of concave portions including an upper contour 60f and a lower contour 60g. A right section of upper contour 60f is configured to accommodate a downwardly extending portion of air intake runners 122 between engine 26 and fuel tank 60. A left section of upper contour 60f is configured to accommodate a downwardly extending portion of air intake runners 122 and a downwardly extending portion of fuel conduit 132 between engine 26 and fuel tank 60. Lower contour 60g is configured to accommodate a downwardly extending portion of air intake runners 122 and the laterally extending fuel rail 134 between engine 26 and fuel tank 60. In the illustrated embodiments, the right section of upper contour 60f has recess depth 152. The left section of upper contour 60f and lower contour 60g have a recess depth 154 wherein, recess depth 152 is less than recess depth 154. This configuration results in an overhang portion 60h above lower contour 60g which can also be describes as being between the right section of upper contour 60f and lower contour 60g. In addition, forward face 60e has an overhang portion 60i that is above upper contour 60f and thus above lower contour 60g. Upper contour 60f extends vertically between overhang portion 60h and overhang portion 60i, as indicated by arrow 156. Lower contour 60g extends vertically between a lower end of forward face 60e and overhang portion 60h, as indicated by arrow 158. The aftwardly tilted engine 26 together with the contoured forward face 60e of fuel tank 60 allow for a portion of air intake system 110 and a portion of fuel system 130 to be positioned between engine 26 and fuel tank 60. In addition, air intake runners 122 are positioned below overhang portion 60i of fuel tank 60 and at least partially beneath overhang portion 60i of fuel tank 60. Fuel rail 134 is positioned below overhang portion 60i, below upper contour 60f and below overhang portion 60h of fuel tank 60. In addition, fuel rail 134 is positioned beneath overhang portion 60i, beneath upper contour 60f and beneath overhang portion 60h of fuel tank 60. Fuel rail 134 is also positioned between a lower portion of air intake runners 122 and fuel tank 26.

The compact positioning of fuel tank of the present disclosure relative to the engine enabled by the uniquely shaped fuel tank of the present disclosure provides numerous benefits to the disclosed snowmobile. For example, by compactly positioning the fuel tank relative to the engine, the fuel tank is positioned substantially forward relative to the rider of the snowmobile which improves the mass centralization of the disclosed snowmobile and maintains a low center of gravity for the disclosed snowmobile, which improves the handling of the disclosed snowmobile. In addition, by compactly positioning the fuel tank relative to the engine, the overall size of the disclosed snowmobile is reduced which improves the aerodynamics of the disclosed snowmobile. Further, by compactly positioning the fuel tank relative to the cool side of the engine, the fuel system components are positioned thermally distant from the exhaust system components and are thus protected from the hot temperatures of the exhaust system.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A fuel system for a snowmobile having a chassis defining an engine bay and an engine positioned within the engine bay, the fuel system comprising:
a fuel tank coupled to the chassis and positioned aft of the engine, the fuel tank having a forward face including a lower contour and an upper contour; and
a fuel rail in fluid communication with the fuel tank and the engine;
wherein, the fuel rail is positioned between the engine and the lower contour of the forward face of the fuel tank.

2. The fuel system as recited in claim 1 wherein, the fuel rail extends laterally between the engine and the lower contour of the forward face of the fuel tank.

3. The fuel system as recited in claim 1 wherein, the fuel rail is positioned below the upper contour of the forward face of the fuel tank.

4. The fuel system as recited in claim 1 wherein, the fuel rail is positioned aft of the engine.

5. The fuel system as recited in claim 1 wherein, the fuel rail is positioned beneath at least a portion of the fuel tank and forward of at least a portion of the fuel tank.

6. The fuel system as recited in claim 1 wherein, the snowmobile includes an air intake system having a plurality of air outlets; and
wherein, the upper contour of the forward face of the fuel tank is configured to accommodate at least a portion of the air intake system between the engine and the fuel tank.

7. The fuel system as recited in claim 6 wherein, the fuel rail extends laterally between a lower portion of the air intake system and the lower contour of the forward face of the fuel tank.

8. The fuel system as recited in claim 6 wherein, the air intake system includes an air plenum positioned on top of the engine and air intake runners positioned at least partially between the engine and the upper contour of the forward face of the fuel tank; and
wherein, the fuel rail is coupled to the air intake runners.

9. A snowmobile comprising:
a chassis including a forward frame assembly defining an engine bay and a tunnel coupled to the forward frame assembly;
an engine positioned within the engine bay and having a plurality of cylinders;
an air intake system having at least one air inlet and a plurality of air outlets, each of the air outlets coupled to the engine and configured to provide air to one of the cylinders; and
a fuel system including a fuel tank coupled to the tunnel and positioned aft of the engine and a fuel rail in fluid communication with the fuel tank and the engine;
wherein, the fuel tank has a forward face that includes a lower contour and an upper contour;
wherein, the fuel rail is positioned between the engine and the lower contour of the forward face of the fuel tank; and
wherein, at least a portion of the air intake system is positioned between the engine and the upper contour of the forward face of the fuel tank.

10. The snowmobile as recited in claim 9 wherein, the engine is a four-stroke engine.

11. The snowmobile as recited in claim 9 wherein, the air intake system further comprises an airbox including the at least one air inlet and air intake runners each including one of the air outlets; and
wherein, the air intake runners are positioned at least partially between the engine and the upper contour of the forward face of the fuel tank.

12. The snowmobile as recited in claim 11 wherein, the air intake runners are positioned below at least a portion of the fuel tank.

13. The snowmobile as recited in claim 11 wherein, the air intake runners are positioned at least partially beneath at least a portion of the fuel tank.

14. The snowmobile as recited in claim 11 wherein, the air intake system further comprises an air plenum positioned on top of the engine; and
wherein, the air intake runners extend aftwardly and downwardly from the air plenum to the engine.

15. The snowmobile as recited in claim 9 wherein, the fuel rail is positioned below the upper contour of the forward face of the fuel tank.

16. The snowmobile as recited in claim 9 wherein, the fuel rail is positioned beneath at least a portion of the fuel tank.

17. The snowmobile as recited in claim 9 wherein, the fuel rail extends laterally between the engine and the lower contour of the forward face of the fuel tank.

18. The snowmobile as recited in claim 9 wherein, the fuel rail is positioned aft of the engine.

19. The snowmobile as recited in claim 9 further comprising an exhaust system including an exhaust manifold coupled to the engine and a muffler in fluid communication with the exhaust manifold.

20. The snowmobile as recited in claim 19 wherein, the exhaust manifold is coupled to a forward side of the engine and the air outlets of the air intake system are coupled to an aft side of the engine.
